(19) United States
(12) Patent Application Publication
(10) Pub. No.: US 2017/0279104 A1
(43) Pub. Date: Sep. 28, 2017

(54) FLEXIBLE CIRCUIT FOR VEHICLE BATTERY

(71) Applicant: Faraday&Future Inc., Gardena, CA (US)

(72) Inventors: William Alan Beverley, Lakewood, CA (US); Hoa Tran, Fountain Valley, CA (US)

(21) Appl. No.: 15/077,739

(22) Filed: Mar. 22, 2016

(51) Int. Cl. H01M 2/20; H01M 2/26

(52) U.S. Cl. CPC H01M 2/206; H01M 2/26; H01M 2220/20

(57) ABSTRACT

Disclosed herein are battery systems for electric vehicles. A battery may include a plurality of electrochemical cells and an flexible circuit disposed above the electrochemical cells. The flexible circuit may be generally defined by a longitudinal and lateral axis. The flexible circuit may include a positive conductive path, a negative conductive path, at least one opening extending through the flexible circuit, at least one expandable positive interconnect capable of electrically connecting the positive path to a positive terminal of an electrochemical cell, and at least one expandable negative interconnect capable of electrically connecting the negative conductive path to a negative terminal of an electrochemical cell. The positive and negative interconnects may be expandable in at least the transverse direction and may extend from an edge of the at least one opening and terminate at a connection pad.

### BACKGROUND

Field

This disclosure relates to vehicle battery systems, and more specifically to systems and methods for transferring electricity to, from, and within vehicle batteries using flexible circuits.

Description of the Related Art

Electric vehicles, hybrid vehicles, and internal combustion engine vehicles generally contain a low voltage automotive battery to provide power for starting the vehicle and/or to provide power for various other electrically powered systems. Automotive batteries typically provide approximately 12 volts, and may range up to 16 volts. Such batteries are typically lead-acid batteries. In electric or hybrid vehicles, a low voltage automotive battery may be used in addition to higher voltage powertrain batteries.

### SUMMARY

The systems and methods of this disclosure each have several innovative aspects, no single one of which is solely responsible for its desirable attributes. Without limiting the scope as expressed by the claims that follow, its more prominent features will now be discussed briefly.

In one implementation, a circuit for a vehicle battery is described. The circuit may include an elongate flexible circuit having at least one positive conductive path and at least one negative conductive path disposed therein. The at least one positive conductive path and the at least one negative conductive path may be separated by at least one insulating material. The circuit may further include at least one opening extending through the circuit and at least one interconnect capable of electrically connecting the positive or negative conductive path to a battery cell. The interconnect may extend from an edge of the at least one opening and terminate at a connection pad. The interconnect may have a conducting length that is greater than a straight line distance between the edge and the connection pad. The interconnect may be capable of expanding in at least one of the lateral, longitudinal, and transverse directions. The interconnect may further be capable of connecting the positive or negative conductive path to a battery cell positioned at least partially beneath the opening. The interconnect may be biased toward the cell and be capable of exerting a downward force in the transverse direction against the cell. The conductive length of the interconnect may be serpentine, and the interconnect may have a conductive length that is at least twice as long as the straight line distance between the edge and the connection pad. The circuit may include at least two interconnects, both extending from an edge of an opening and terminating at a connection pad. At least one interconnect may be a positive interconnect configured to electrically connect a positive terminal of the battery cell and the positive conductive path, and at least one interconnect may be a negative interconnect configured to electrically connect a negative terminal of the battery cell and the negative conductive path. The at least one positive interconnect and the at least one negative interconnect may extend into a single opening of the flex circuit, and the at least one negative interconnect may not contact or overlap the at least one positive interconnect.

In another implementation, a circuit for a vehicle battery is described. The circuity may include an elongate flexible circuit generally defined by a lateral and longitudinal axis. The elongate flexible circuit may have at least one conductive path disposed therein. The circuit may further include at least one opening extending through the circuit and at least two expandable interconnects capable of electrically connecting the conductive path to a battery cell positioned at least partially beneath the opening. The expandable interconnects may extend from an edge of the at least one opening and terminate at a connection pad capable of connecting to a terminal of a battery cell. The interconnects may be capable of expanding in at least one of the longitudinal, lateral, and transverse directions. The expandable interconnects may have a conducting length that is greater than a straight line distance between the edge and the connection pad. The interconnects may be serpentine along the conducting length and may be biased toward the battery cell. The interconnects may be capable of exerting a downward force in the transverse direction against the top surface of a battery cell. The circuit may further include at least three expandable interconnects, each extending from an edge of the at least one opening and terminating at a connection pad, and wherein a plurality of connection pads are capable of connecting to a single terminal of a battery cell. The interconnects configured to connect with a positive terminal of a battery cell may not contact or overlap the interconnects configured to connect with a negative terminal of the battery cell.

In another implementation, a vehicle battery is described. The battery may include a plurality of electrochemical cells and an elongate planar flexible circuit disposed above the electrochemical cells. The flexible circuit may be generally defined by a longitudinal and lateral axis, and may include a positive conductive path, a negative conductive path, at least one opening extending through the flexible circuit, at least one expandable positive interconnect capable of electrically connecting the positive path to a positive terminal of an electrochemical cell, and at least one expandable negative interconnect capable of electrically connecting the negative conductive path to a negative terminal of an electrochemical cell. The positive and negative interconnects may be expandable in at least the transverse direction and may extend from an edge of the at least one opening and terminate at a connection pad. Each interconnect may have a conducting path length that is greater than a straight line distance between the edge and the connection pad. The battery may further include a plate contacting at least a portion of the circuit, the plate being less flexible than the circuit.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1A is a schematic illustration of a contact pad and compressible interconnect of a flex circuit in an uncoupled state in accordance with an exemplary embodiment.

FIG. 1B is a schematic illustration of the contact pad and compressible interconnect of the flex circuit of FIG. 1A coupled to an electrochemical cell in accordance with an exemplary embodiment.

FIG. 1C is a schematic illustration of a contact pad and extendable interconnect of a flex circuit in an uncoupled state in accordance with an exemplary embodiment.

FIG. 1D is a illustration representation of the contact pad and extendable interconnect of the flex circuit of FIG. 1C coupled to an electrochemical cell in accordance with an exemplary embodiment.

FIG. 2A is a top view of a flex circuit in accordance with an exemplary embodiment.

FIG. 2B is an enlarged perspective view of the flex circuit of a portion of the flex circuit of FIG. 2A coupled to a plurality of electrochemical cells in accordance with an exemplary embodiment.

FIG. 2C is a cross sectional view taken about the line 2C-2C of a positive interconnect and contact pad in accordance with the embodiment depicted in FIG. 2B.

FIG. 2D is a cross sectional view taken about the line 2D-2D of two negative interconnects and a contact pad in accordance with the embodiment depicted in FIG. 2B.

FIG. 2E is the cross sectional view of FIG. 2C showing a positive interconnect coupled to a positive cell terminal. As shown, the positive interconnect expands to span the gap between the flex circuit and the cell.

FIG. 2F is the cross sectional view of FIG. 2D showing two negative interconnects coupled to a negative cell terminal. As shown, the negative interconnect expands to span the gap between the flex circuit and the cell.

### DETAILED DESCRIPTION

A flex circuit having expandable interconnects is disclosed. The following description is directed to certain implementations for the purpose of describing the innovative aspects of this disclosure. However, a person having ordinary skill in the art will readily recognize that the teachings herein can be applied in a multitude of different ways.

In some implementations, the word “battery” or “batteries” will be used to describe certain elements of the embodiments described herein. It is noted that “battery” does not necessarily refer to only a single battery cell. Rather, any element described as a “battery” or illustrated in the Figures as a single battery in a circuit may equally be made up of any larger number of individual battery cells and/or other elements without departing from the spirit or scope of the disclosed systems and methods.

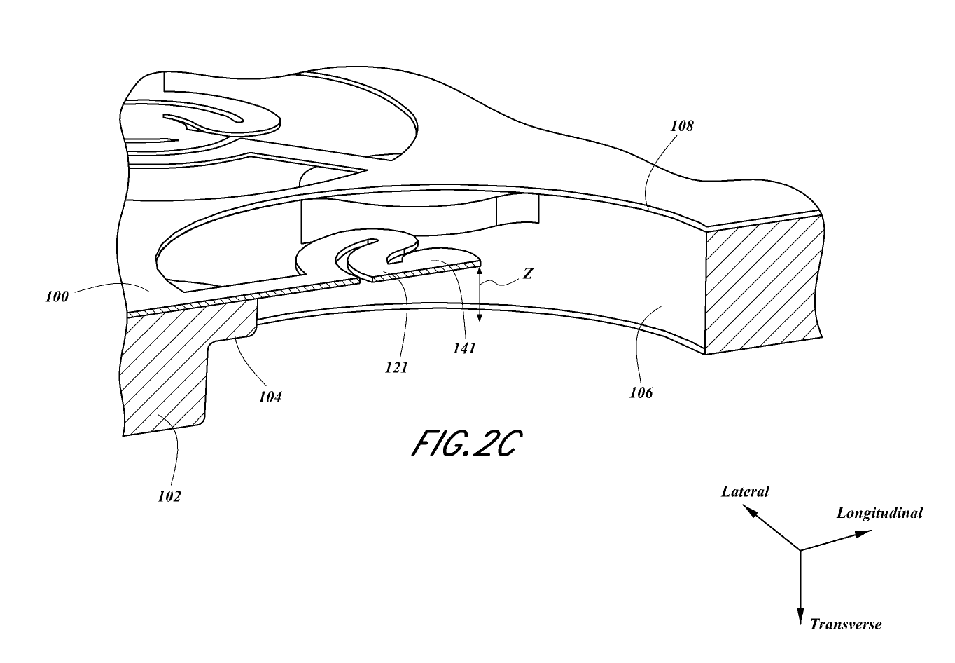

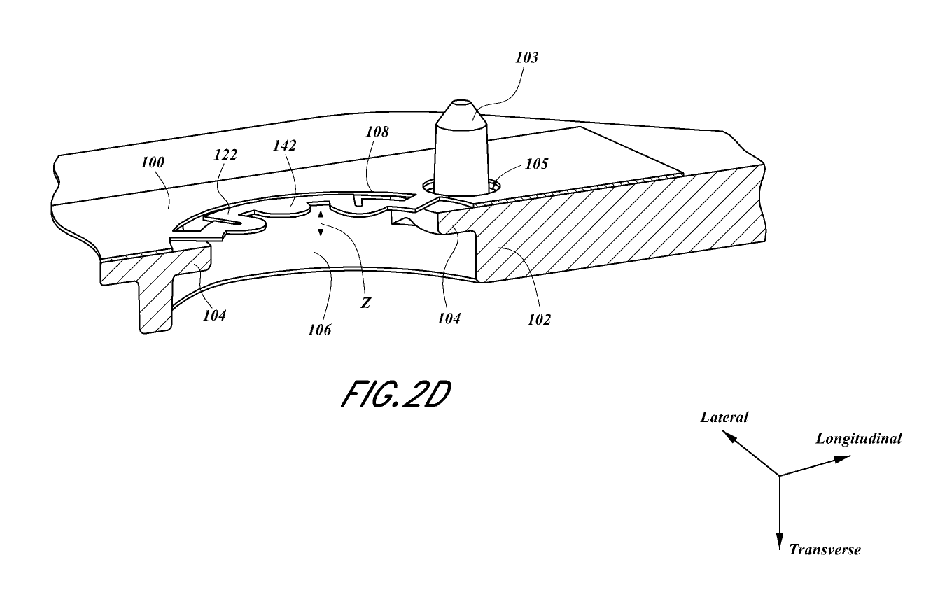

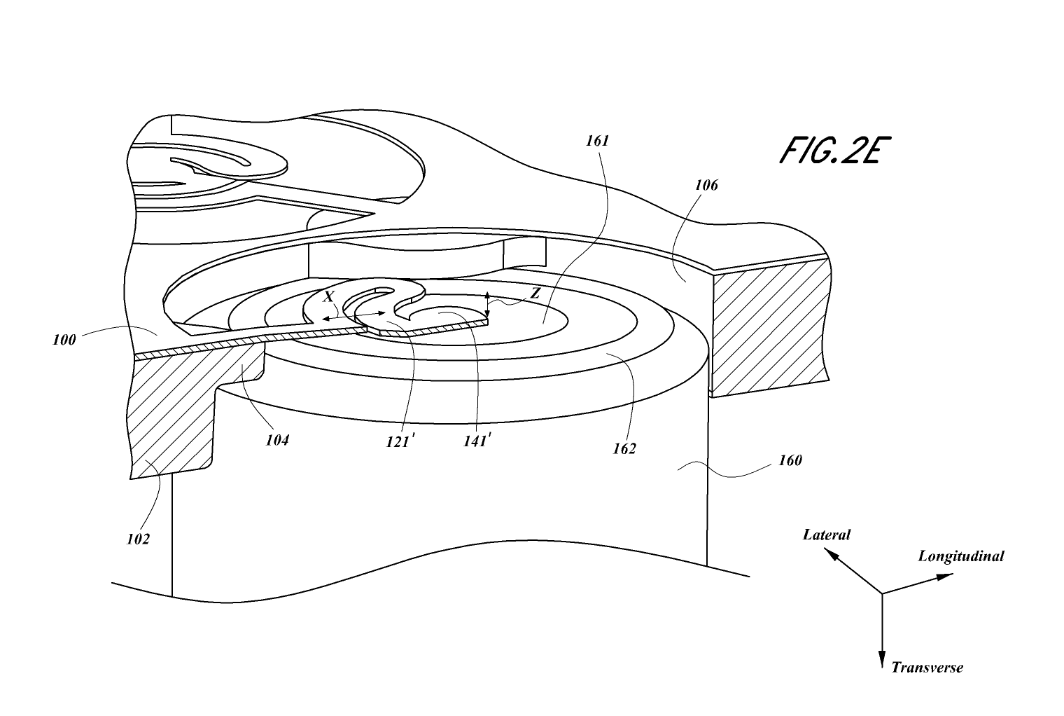

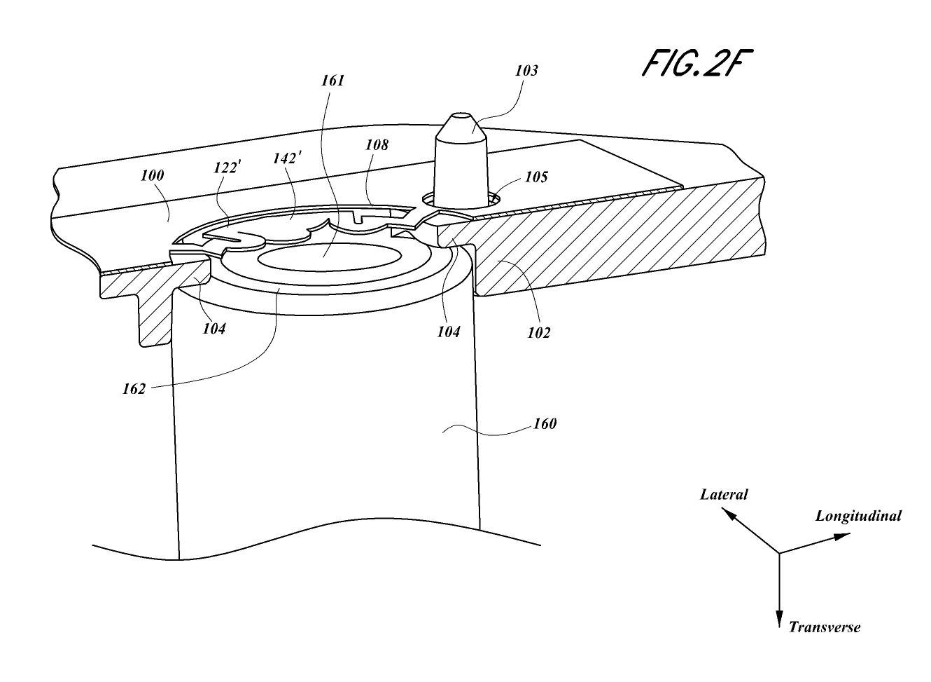

To assist in the description of various components of the flexible circuits and battery systems, the following coordinate terms are used (see, e.g., FIGS. 2C-2D). A “longitudinal axis” is generally parallel to the longest dimension of the flex circuit embodiments depicted. A “lateral axis” is normal to the longitudinal axis. A “transverse axis” extends normal to both the longitudinal and lateral axes. For example, the close perspective view of FIG. 2A depicts a plurality of electrochemical cells coupled to a flex circuit having an array of circular holes; each row of holes is oriented along a line parallel to the longitudinal axis, while each cell is oriented parallel to the transverse axis.

In addition, as used herein, the “longitudinal direction” refers to a direction substantially parallel to the longitudinal axis, the “lateral direction” refers to a direction substantially parallel to the lateral axis, and the “transverse direction” refers to a direction substantially parallel to the transverse axis.

The terms “upper,” “lower,” “top,” “bottom,” “underside,” “top side,” “above,” “below,” and the like, which also are used to describe the present battery systems, are used in reference to the illustrated orientation of the embodiment. For example, as shown in FIG. 2B, the term “underside” may be used to describe the surface of the flex circuit to which the electrochemical cells are coupled, while the term “top side” may be used to describe the opposite, visible surface of the flex circuit.

Traditional gasoline powered cars typically include a low voltage SLI (starting, lighting, ignition) battery. Similarly, electric vehicles may include a low voltage SLI battery along with a high voltage battery system having significant energy storage capacity and suitable for powering electric traction motors. The low voltage battery may be necessary to provide the startup power, power an ignition, close a high voltage battery contactor, and/or power other low voltage systems (e.g., lighting systems, electronic windows and/or doors, trunk release systems, car alarm systems, and the like).

In addition to powering the vehicle's propulsion motors, the high voltage batteries' output may be stepped down using one or more DC-to-DC converters to power some or all of the other vehicle systems, such as interior and exterior lights, power assisted braking, power steering, infotainment, automobile diagnostic systems, power windows, door handles, and various other electronic functions when the high voltage batteries are engaged.

High voltage batteries may be connected to or isolated from other vehicle circuitry by one or more magnetic contactors. Normally open contactors require a power supply in order to enter or remain in the closed circuit position. Such contactors may be configured to be in the open (disconnected) configuration when powered off to allow the high voltage batteries to remain disconnected when the vehicle is powered off. Thus, on startup, a small power input is required to close at least one contactor of the high voltage battery pack. Once a contactor is closed, the high voltage batteries may supply the power required to keep the contactor(s) closed and/or supply power to other vehicle systems.

The low voltage battery may include a housing containing a plurality of electrochemical cells that are electrically coupled by a circuit. The circuit may be a flexible circuit. Flexible circuits or flex circuits may include a plurality of conductive paths. Flex circuits may include components that are identical and/or similar to component of a rigid printed circuit board but may configured to conform to a desired shape and/or flex during use. Flexible circuit boards may become disconnected from one or more cells during driving because of, for example, vibrations and/or mechanical shock. Flexible circuits may include a plurality of layers. In some aspects, a flex circuit includes at least two conductive layers and at least one insulating layer. In some aspects, the layers may be laminated together.

Particular embodiments of the subject matter described by this disclosure can be implemented to realize one or more of the following potential advantages. Rather than using a traditional lead-acid automobile battery, the present allows for a smart rechargeable battery that does not require a fluid filled container. In some aspects, one or more individual cells in a housing may be monitored individually or in subsets. In some aspects, additional individual cells may be provided within the housing such that the connected cells can provide more voltage than necessary to compensate for the potential of the loss of one or more of the cells. The disclosed design may be easier and/or less expensive to manufacture. For example, the number of manufacturing steps may be minimized and the labor may be simplified and/or made more efficient. For example, a flex circuit may be used to electrically connect the plurality of cells. Such a circuit may be compact, lightweight, and/or able to withstand the forces and/or vibrations experienced by a vehicle while driving. That is to say, the circuit is designed to prevent the circuit from becoming disconnected from the one or more cells during vehicle operation.

In some aspects a flexible circuit has a plurality of expandable interconnects. The interconnects may physically and electrically connect the circuit to a plurality of cells. The expandable interconnects may allow for the batteries to move in one or more of the lateral, longitudinal, and transvers directions with respect to the circuit without being disconnected from the circuit. The expandable nature of the interconnects may also allow for the interconnects to expand and/or contract in one or more of the lateral, longitudinal, and transverse directions. The expandable interconnects may also allow for the batteries to rotate about one or more of the lateral, longitudinal, and transvers directions with respect to the circuit without being disconnected from the circuit.

The interconnects may be configured to span a distance between the flex circuit and the cell terminal. In some aspects, the interconnects impart a downward force on the cells in order to help maintain contact with the cells. In some aspects, the interconnects relieve tension from a center weld point. The interconnects may include multiple contacting surfaces with each cell to increase redundancy and to preserve functionality even if one connection point fails.

These, as well as other various aspects, components, steps, features, objects, benefits, and advantages will now be described with reference to specific forms or embodiments selected for the purposes of illustration. It will be appreciated that the spirit and scope of the systems and methods disclosed herein is not limited to the selected forms. Moreover, it is to be noted that the figures provided herein are not drawn to any particular proportion or scale, and that many variations can be made to the illustrated embodiments.

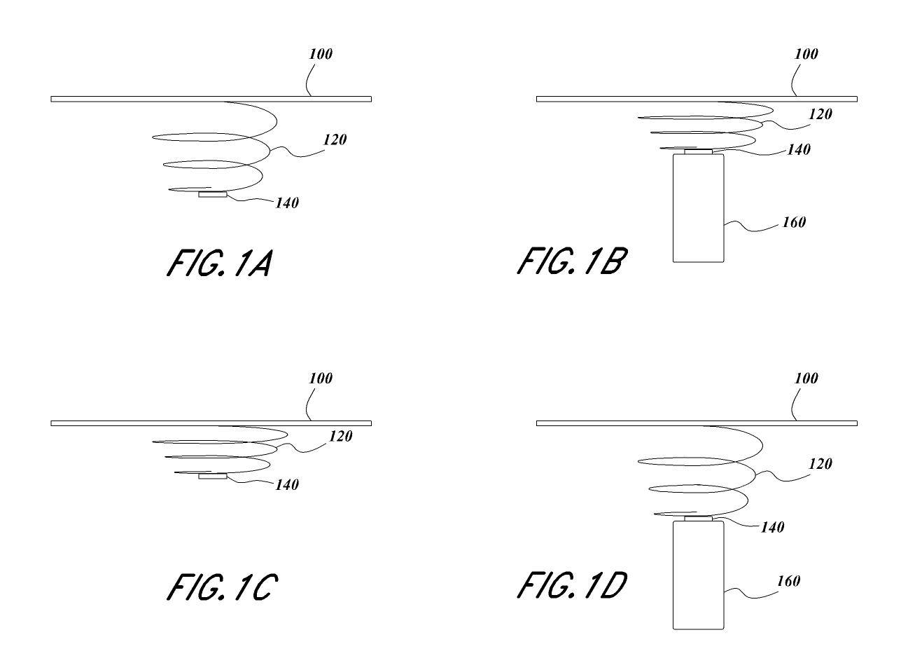

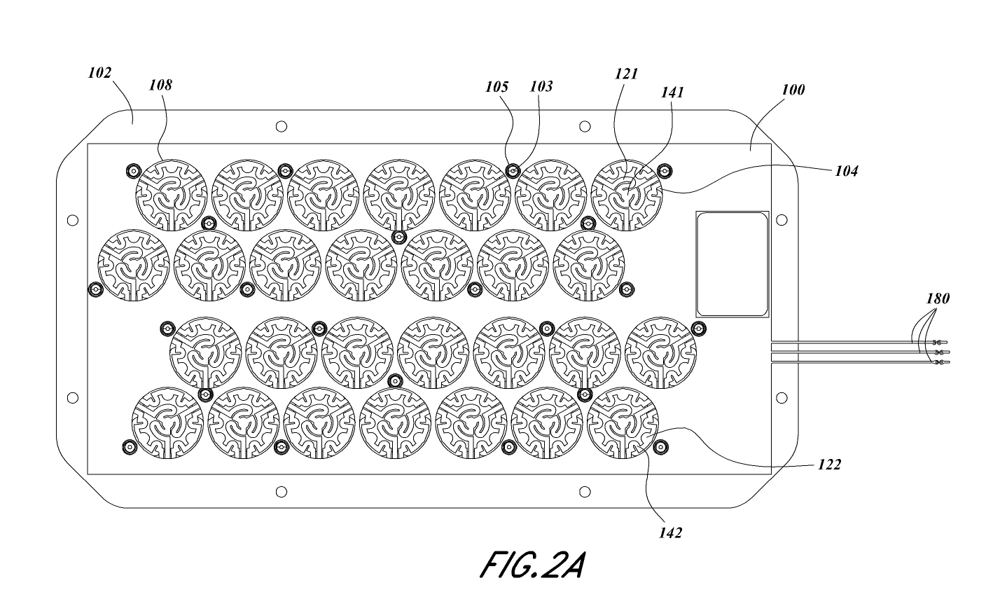

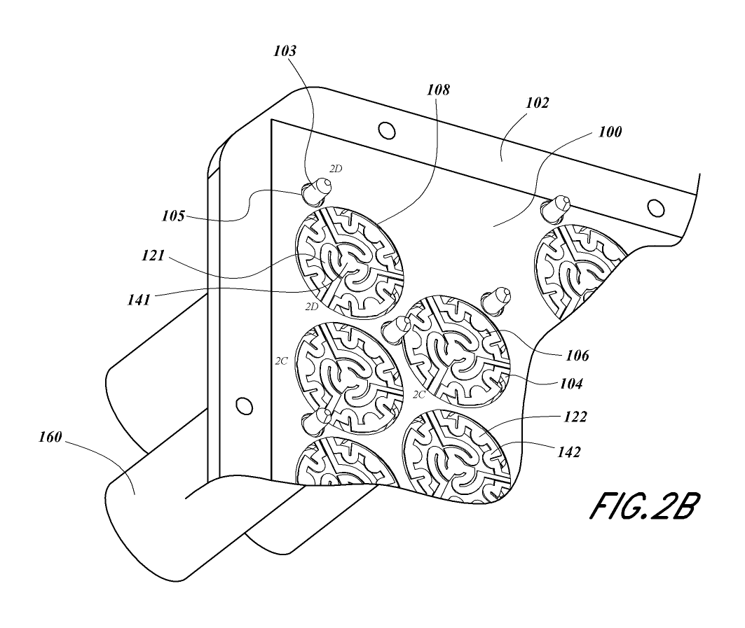

FIGS. 1A-1D are schematic illustrations of a portion of a flex circuit 100 configured to connect with an electrochemical cell 160. FIGS. 1A and 1C depict the flex circuit 100 in an uncoupled state without an electrochemical cell 160, such as before battery assembly. FIGS. 1B and 1D depict the flex circuit 100 coupled with an electrochemical cell 160. A flex circuit 100 may include one or more interconnects 120 connecting a conductive path of the flex circuit 100 to connection pads 140 configured to contact a positive or negative terminal of an electrochemical cell 160. The interconnects may include spring like components that can expand and contract.

During vehicle operation, a battery may be subjected to forces, movements, and/or vibrations in the longitudinal, lateral, and/or transverse directions. Such forces, movements, and/or vibrations may cause the battery connection circuitry, such as a connection pad 140 of flex circuit 100, to lose contact with the terminals of the electrochemical cells 160. Thus, connection pad 140 may be secured to a cell 160, such as by welding or other suitable mechanical restraint, so as to maintain electrical contact between the cell 160 and the flex circuit 100. To avoid excessive stress on the interconnects 120, the interconnects 120 may be flexible and/or springy, allowing the interconnect 120 to absorb force, movement, and/or vibration in the longitudinal, lateral, and/or transverse direction. In this way, the chances that an interconnect becomes disconnects from a terminal may be reduced or eliminated.

In some embodiments, the interconnect 120 may be biased downward so as to exert a force against the top surface of a cell 160. For example, comparing FIG. 1A with FIG. 1B, the interconnect 120 may be compressed from its resting state of FIG. 1A by inserting a cell 160 as shown in FIG. 1B. In some aspects, the force exerted against the top of the cell 160 may facilitate the continuity of the connection between the connection pad 140 and the cell 160 during vibration in the transverse direction.

In some embodiments, the interconnect 120 may be unbiased or may be only slightly biased downward in its uncoupled state, as shown in FIG. 1C. In such embodiments, the interconnect 120 may be pressed downward when coupling with a cell 160 such that the connection pad 140 contacts the top of the cell 160. The connection pad 140 may then be secured to the top of the cell 160 via welding or other method, as described above. In some aspects, an interconnect 120 that is unbiased in its uncoupled state may be easier to manufacture, for example, if the interconnect 120 is formed as an integral part of a conductive portion of a flex circuit 100.

FIG. 2A is a top view of an exemplary configuration of a battery connection flex circuit 100. The flex circuit 100 may include a plurality of openings 108, each configured to receive at least a portion of an electrochemical cell 160 (not shown). While described as openings, one may appreciate that the interconnects may be formed by one or more conductive layers of the flex circuit. That is to say, in general, the openings are not separately formed and then filled by the interconnects. Rather, the interconnects are formed during the manufacturing of the layered flex circuit.

Continuing with FIG. 2A, the openings 108 may contain one or more positive connection pads 141 configured to contact the positive terminal of an electrochemical cell 160 (not shown). The positive connection pads 141 may be connected to a conductive path of the flex circuit 100 at the edge of the opening 108 by a conductive positive interconnect 121. Similarly, each opening 108 may contain one or more negative connection pads 142 configured to contact the negative terminal of an electrochemical cell 160 (not shown). Each negative connection pad 142 may be connected to a conductive path of the flex circuit 100 at the edge of the opening 108 by a conductive negative interconnect 122.

In some embodiments, some or all of the interconnects 121, 122 may be supported near the edges of the openings 108 by battery spacing projections 104. The flex circuit 100 may be surrounded and/or supported by a cell holder framework 102, which may support the flex circuit 100 by extending below some or all of the flex circuit 100. In some embodiments, the openings 108 of the flex circuit may be substantially coextensive with openings 106 (not shown) of the cell holder framework 102. Battery spacing projections 104 may be formed as part of the cell holder framework 102. In some aspects, the cell holder framework 102 includes a plate that is less flexible (i.e. more rigid) than the flex circuit. The cell holder framework 102 may serve to increase the relative rigidity of the flex circuit. That is to say, the cell holder framework 102 may inhibit the flexing and/or movement of the flex circuit with respect to the cells. In this way, the interconnects may be configured to flex, move, and/or expand relative to the flex circuit.

The flex circuit 100 may include monitoring connections 180 extending from the conductive paths of the flex circuit 100 to battery monitoring circuitry (not shown) for voltage measurements or other diagnostics. In some embodiments, the conductive paths and/or layers of the flex circuit 100 may be covered and/or separated by one or more layers of electrically insulating material such as polyimides, PET, PEEK, or Kapton.

FIG. 2B is an enlarged top perspective view of the flex circuit 100 of FIG. 2A coupled to a plurality of electrochemical cells 160. For illustrative purposes, three cells 160 are attached to the flex circuit 100 at three openings 108, while the other openings 108 are uncoupled. In some embodiments, each connection pad 141, 142 may be connected to the edges of an opening 108 by a plurality of interconnects 121, 122. Interconnects 121, 122 may provide both physical and electrical connection between the connection pad 141, 142 and the flex circuit 100. Providing more than one interconnect 121, 122 for each connection pad 141, 142 may provide several potential advantages. Attachment with multiple interconnections may help the connection pad 141, 142 to remain in its desired location. For example, in the depicted embodiment, the positive connection pad 141 is connected to the flex circuit 100 by three interconnects 121 evenly spaced around the circular opening 108 so as to keep the connection pad 141 centered within the opening 108. Similarly, each negative connection pad 142 may be connected to the flex circuit 100 by two interconnects 122 so as to prevent the connection pad 142 from moving along the perimeter of the opening 108. Further redundancy may be achieved by providing a plurality of connection pads 141, 142 for a single terminal 161, 162. For example, where the negative terminal of a cell 160 includes a ring around the perimeter of the top surface of the cell 160, each opening 108 in the flex circuit 100 may include three negative connection pads 142 arranged around the perimeter of the opening 108, each connected to the flex circuit 100 by two interconnects 122.

In some embodiments, interconnects 121, 122 may be curved and/or angled so as to form an indirect connection between a main conducting path of the flex circuit 100 and a connection pad 141, 142. Such shapes and/or arrangements create a conductive length along the interconnect 121, 122 longer than the shortest distance between the connection pad 141, 142 and the edge of the opening 108 of the flex circuit. For example, each positive interconnect 121 depicted in FIG. 2B has a conductive path of which two portions travel radially outward from the connection pad 141 to the edge of the circular opening 108. Between the two straight radial sections, the interconnect 121 includes a curved segment traveling in a circumferential direction to a 180° curve and traveling back to the original radial conductive path. Similarly, each negative interconnect 122 includes three angled portions and a 180° curved section to create a conductive length greater than the straight line distance from the connection pad 142 to the edge of the opening 108. For example, an interconnect may include a conductive length 50% longer than the straight line distance or longer, such as twice as long, three times as long, etc. The additional length of conductive material may provide additional flexibility for the interconnects 121, allowing them to act as springs to absorb force, motion, and/or vibration in the longitudinal, lateral, and/or transverse directions and avoid transferring mechanical stress to the weld between the connection pad 141 and the positive terminal 161 of the electrochemical cell 160.

As described above, flexible and/or springy interconnects 121, 122 may be expandable to allow the flex circuit assembly to accommodate forces, motion, and/or vibration in the longitudinal, lateral, and transverse directions. Such expandability allows for a more rigid flex circuit. Thus, the flex circuit 100 may remain substantially rigid. For example, the flex circuit 100 may be supported by a structure such as a cell holder framework 102 comprising a material such as a hard plastic, a metal, or other substantially rigid material. In some embodiments, the flex circuit 100 may be attached to a cell holder framework 102, described above, such as by flex circuit securing studs 103, described in greater detail below with reference to FIG. 2D.

An assembly process for connecting a plurality of electrochemical cells 160 using a flex circuit 100 will now be described with reference to FIG. 2B. A plurality of cells 160 may be positioned in an array matching the layout of openings 108 in the flex circuit assembly. For example, a lower cell holder framework (not shown) may include a plurality of openings of substantially the same size, shape, and location as the openings 108 of the flex circuit 100 and the openings 106 of an upper cell holder framework 102 to which the flex circuit 100 may be attached, as described elsewhere herein. The flex circuit 100 and cell holder framework 102 may be placed on top of the plurality of electrochemical cells 160 so that each of the cells 160 is inserted into one of the openings 106 of the framework 102. In some embodiments, the openings 106 of the framework 102 may include cell spacing projections 104 to maintain a separation in the transverse direction between the terminals 161, 162 of the cells 160 and the plane of the flex circuit 100. A transverse separation between the terminals 161, 162 and the plane of the flex circuit 100 may prevent unwanted electrical connections and/or prevent trauma to the flex circuit 100 from vibration or motion of the cells 160.

Continuing with FIG. 2B, the connection pads 141, 142 may be connected to the terminals 161, 162 of the cells 160. The connection process is illustrated in FIGS. 2C-2F. For example a positive connection pad 141 may be pressed downward a distance z in the transverse direction from its initial position, as shown by connection pad 141 in FIG. 2C, to a depressed position, as shown by connection pad 141′ in FIG. 2E, where it is in contact with the top surface of the positive terminal 161 of a cell 160. Similarly, a negative connection pad 142 may be pressed downward a distance z in the transverse direction from it is initial position, as shown by connection pad 142 in FIG. 2D, to a depressed position, as shown by connection pad 142′ in FIG. 2F, where it is in contact with the top surface of the negative terminal 162 of a cell 160. Moving connection pads 141, 142 to their depressed positions 141′, 142′ may cause interconnects 121, 122 to move from their initial unbiased positions, as shown in FIGS. 2C and 2D, to the sloped positions shown by interconnects 121′ and 122′ in FIGS. 2E and 2F. In their depressed positions, connection pads 141′ and 142′ may be secured to the terminals 161, 162 of the cells 160 by welding or other securing method.

In some embodiments, the uncoupled configuration of interconnects 121 and 122 (i.e., the configuration as manufactured, before attachment to electrochemical cells 160) may be unbiased (i.e., the interconnects are substantially within the plane of the flex circuit 100 before coupling with cells 160), as depicted in FIGS. 2B, 2C, and 2D, similar to the embodiments depicted in FIGS. 1C and 1D. In such embodiments, a weld or other securing means as described above may be necessary to maintain an electrical connection between the electrochemical cells 160 and the connection pads 141, 142. In some embodiments, the uncoupled configuration of interconnects 121 and 122 may be biased, such as the embodiments depicted in FIGS. 1A and 1B. In such embodiments, the spring force exerted on the cell 160 by the interconnects 121, 122 may maintain the electrical connection between the cell 160 and the connection pads 141, 142 without further securing measures. However, a weld or other securing method may still be employed with such embodiments so as prevent a loss of connection due to vibration or other motion that may be encountered during operation of the vehicle.

FIGS. 2C and 2D are cross-sectional views of interconnects 121, 122 and contact pads 141, 142 in their uncoupled configurations in accordance with the embodiment depicted in FIG. 2B. FIGS. 2E and 2F are cross-sectional views of interconnects 121′ and 122′ in their coupled configurations, as described above. FIG. 2E depicts a positive interconnect 121′ and connection pad 141′ connected to the positive terminal 161 of an electrochemical cell 160, while FIG. 2F depicts a negative interconnect 122′ and contact pad 142′ connected to the negative terminal 162 of an electrochemical cell 160. Note that the spring like construction of flexible interconnects 121′ and 122′ allows for accommodation of vibration or other motion in the transverse direction. In addition, the shape of the depicted positive interconnect 121′ may also allow for the accommodation of motion x in the longitudinal direction.

As discussed above, the flex circuit 100 may be secured to a cell holder framework 102 at flex circuit securing studs 103. The flex circuit 100 may include holes sized and shaped to accommodate studs 103. Thus, the flex circuit 100 may be placed on top of the framework 102 and held in place by the studs 103. To maintain the flex circuit 100 in the desired location, and to provide additional durability, heat staking may be used to deform the studs 103, forming a precise fit with the flex circuit 100. In some embodiments, the cell holder framework 102 may include heat staking wells 105 surrounding the studs 103. The heat staking wells 105 may provide additional space to accommodate the melted plastic created in the heat staking process. The increased surface area of the wells 105 may further strengthen the interference fit between the stud 103 and the flex circuit 100.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. A circuit for a vehicle battery, the circuit comprising:
a flexible circuit having at least one positive conductive path and at least one negative conductive path disposed therein, the at least one positive conductive path and the at least one negative conductive path separated by at least one insulating material;
at least one opening extending through the circuit; and
at least one interconnect capable of electrically connecting the positive or negative conductive path to a battery cell, the interconnect extending from an edge of the at least one opening and terminating at a connection pad, the interconnect having a conducting length that is greater than a straight line distance between the edge and the connection pad.

2. The circuit of claim 1, wherein the interconnect is capable of expanding in at least one of the lateral, longitudinal, and transverse directions.

3. The circuit of claim 2, wherein the interconnect is capable of connecting the positive or negative conductive path to a battery cell positioned at least partially beneath the opening.

4. The circuit of claim 3, wherein the interconnect is biased toward the cell and is capable of exerting a downward force in the transverse direction against the cell.

5. The circuit of claim 1, wherein the conducting length of the interconnect is serpentine.

6. The circuit of claim 1, wherein the interconnect has a conductive length that is at least twice as long as the straight line distance between the edge and the connection pad.

7. The circuit of claim 1, wherein the circuit comprises at least two interconnects, both extending from an edge of an opening and terminating at a connection pad, and wherein at least one interconnect is a positive interconnect configured to electrically connect a positive terminal of the battery cell and the positive conductive path, and wherein at least one interconnect is a negative interconnect configured to electrically connect a negative terminal of the battery cell and the negative conductive path.

8. The circuit of claim 7, wherein the at least one positive interconnect and the at least one negative interconnect extend into a single opening of the flex circuit.

9. The circuit of claim 7, wherein the at least one negative interconnect does not contact or overlap the at least one positive interconnect.

10. A circuit for a vehicle battery, the circuit comprising:
a flexible circuit generally defined by a lateral and longitudinal axis, the flexible circuit having at least one conductive path disposed therein;
at least one opening extending through the circuit; and
at least two expandable interconnects capable of electrically connecting the conductive path to a battery cell positioned at least partially beneath the opening, the expandable interconnects extending from an edge of the at least one opening and terminating at a connection pad capable of connecting to a terminal of a battery cell.

11. The circuit of claim 10, wherein the interconnects are capable of expanding in at least one of the longitudinal, lateral, and transverse directions.

12. The circuit of claim 10, wherein the expandable interconnects have a conducting length that is greater than a straight line distance between the edge and the connection pad.

13. The circuit of claim 12, wherein the interconnects are serpentine along the conducting length.

14. The circuit of claim 10, wherein the interconnects are biased toward the battery cell.

15. The circuit of claim 14, wherein the interconnects are capable of exerting a downward force in the transverse direction against the top surface of a battery cell.

16. The circuit of claim 10, wherein the circuit comprises at least three expandable interconnects, each extending from an edge of the at least one opening and terminating at a connection pad, and wherein a plurality of connection pads are capable of connecting to a single terminal of a battery cell.

17. The circuit of claim 10, wherein the interconnects configured to connect with a positive terminal of a battery cell do not contact or overlap the interconnects configured to connect with a negative terminal of the battery cell.

18. A vehicle battery, the battery comprising:
a plurality of electrochemical cells; and
an elongate planar flexible circuit disposed above the electrochemical cells, the flexible circuit generally defined by a longitudinal and lateral axis, the flexible circuit comprising:
a positive conductive path;
a negative conductive path;
at least one opening extending through the flexible circuit;
at least one expandable positive interconnect capable of electrically connecting the positive conductive path to a positive terminal of an electrochemical cell; and
at least one expandable negative interconnect capable of electrically connecting the negative conductive path to a negative terminal of an electrochemical cell;
wherein the positive and negative interconnects are expandable in at least the transverse direction and extend from an edge of the at least one opening and terminating at a connection pad.

19. The battery of claim 18, wherein each interconnect has a conducting path length that is greater than a straight line distance between the edge and the connection pad.

20. The battery of claim 18, further comprising a plate contacting a least a portion of the circuit, the plate being less flexible than the circuit.
